(19) United States
(12) Patent Application Publication
(10) Pub. No.: US 2012/0245995 A1
(43) Pub. Date: Sep. 27, 2012

(54) METHOD AND SYSTEM FOR ENABLING LOCATION BASED ADVERTISEMENTS WITH PAY FOR PERFORMANCE

(75) Inventor: Neeraj Chawla, Bothell, WA (US)

(73) Assignee: MPANION, INC., Bellevue, WA (US)

(21) Appl. No.: 13/052,193

(22) Filed: Mar. 21, 2011

(51) Int. Cl. G06Q 30/00

(52) U.S. Cl. 705/14.45; 705/14.41; 705/14.4; 705/16

(57) ABSTRACT

A system for offering mobile location based advertisements based on a pay for performance method is presented. The system serves and tracks advertisements and business locations searched and viewed by a user, and can determine if the user visited the business location and performed a transaction at the location in a specified timeframe of the advertisement. The advertising costs are determined based on cost per action models such as a cost per visit (CPV) or a cost per transaction (CPT). Additionally, a system to verify user visits, advertisement codes and transactions in a local business environment is presented, which can also be used for sending an electronic receipt of the transaction to the user's mobile device.

### BACKGROUND

Location based advertisements are gaining acceptance in the mobile industry as a method for monetization of applications and services, especially for the free applications and services consumers have come to expect in the mobile and online industry. In the gold rush for market share in the location based advertisements, companies and ad networks often overlook the implications for consumer's location privacy. According to a recent survey and a series of articles published by the Wall Street Journal, many companies have been found to be collecting and sharing users' personal information without their permission or knowledge.

As leading companies such as Google, Microsoft and Apple also target mobile advertising as a significant revenue opportunity, analysts are projecting that mobile advertising may grow bigger than the online advertising market. However, such a substantial growth in the mobile advertising may come at the cost of putting consumer's privacy at a greater risk.

A significant number of mobile applications are now available free of cost to consumers, and although some may remain free of advertising, many applications are likely to include advertising in the applications. While advertising can lower the costs to consumers, consumers are often not aware of the privacy policies and terms of use associated with such practices.

Further, in order to make the advertisements more relevant to consumers, several forms of targeting methods are used, which are often based on collecting user's profile, behavior, and location. In case of online advertisements, location is often determined based on user's IP address, and are typically approximated to the zip code. However, in the case of mobile devices, advertisements can be targeted based on user's precise location, which puts consumer location privacy at a much higher risk.

According to a research study on consumer behavior and preferences conducted by University of Washington Bothell MBA Program, over 50% of users indicated they were not at all interested in sharing their location information with the social networking sites, and nearly all indicated their preference to control and manage how they shared their location information, even with the people they knew.

In order to realize the potential benefits of offering location based advertising, consumer privacy concerns must be addressed by the industry. A major contributing factor that leads companies and ad networks to compromise consumer privacy is how the online and mobile advertisements are measured and monetized.

A widely accepted practice in the online advertising industry, as well as in the mobile advertising industry, is to use conversion metrics such as cost per impressions (CPM) and cost per click (CPC) to monetize and measure the effectiveness of an online advertisement. Since the conversion rates are typically quite low, e.g. less than 1% for online or print advertisements, advertisers end up marketing to a large number of users to achieve the results of their campaigns. While these metrics are widely used to drive mass-marketing campaigns, they can often lead to privacy compromises when it comes to mobile advertising, especially in the case of mobile location based advertising.

A major part of the challenge in addressing this problem is that in order for targeted location based advertising to work, users' location profile and preferences have to be determined. However, users are often not interested in a sharing their location profile which may be used for mass-marketing purposes or shared with advertisers without their permission. While location based targeting can offer an alternative to mass-marketing practices that require broadcasting to a large number of users in order to achieve the campaign results, advertisers need a measurable and verifiable location based advertising solution that offers an alternative to the views and clicks based solutions of the online advertising industry.

### SUMMARY

A novel approach to offering mobile location based advertisements and measuring performance of such advertisements based on a pay for performance method is presented.

In mobile advertising scenarios, the location of the user can not only be used to offer targeted location based advertisements, but also to measure the performance of the advertisement. In one embodiment of the invention, a solution to measure the performance of an advertisement associated with a business location based on the number of customers that visit the location after viewing that advertisement is offered. In such a pay for performance system, the advertising costs are determined based on the number of customer visits to the location within a specified timeframe after viewing the local advertisement and a cost per visit (CPV) metric.

In another embodiment of the invention, a cost per transaction (CPT) is used where the advertiser is charged based on the number of customer visits that result in a transaction, which in addition to verifying that the user visited the location, also requires verification of the transaction by the user.

In another embodiment of the invention, the location based advertisements are offered to the user in a non-intrusive manner using a pull-based method after the user searches for the relevant location categories based on their location and search criteria, and only after the user selects the relevant locations from search results that are indicated to have an advertisement or special promotion, the advertisement is presented.

Another aspect of such a pull-based advertising solution is that the effectiveness of an advertisement in such as system is not based on views or clicks, and this approach not only reduces the intrusiveness of advertisements, but also provides relevant and targeted advertisements to the user, as the user is involved in self-selecting the local business locations and the associated advertisements they are interested in viewing.

Another aspect of the invention is the system to keep track of the business locations searched and associated advertisements viewed by the user, and further determining if the user visited the location and conducted commerce at the location in a specified timeframe in order to offer a pay for performance solution based on visits and transactions.

In one embodiment of the invention, the user's visit to the local business is used as the basis of enabling a cost per visit (CPV) model, and only aggregate number of customer visits are sent to the merchant to ensure privacy of the users' personal information, unless the user specifically opts-in to receive direct messaging and promotions from the local business.

In another embodiment of the invention, the user's transaction information at the local business is used as the basis of enabling a cost per transaction (CPT) model, and a system for verification of transaction is presented.

In order to enable a verifiable cost per transaction model, one aspect of the invention is to capture the required transaction information by enabling the user to confirm the receipt of transaction using the mobile device. Alternatively, the verification can be performed by capturing the transaction information at the point of sale by alternative methods such as integrating with the business accounting system, and/or by offering users incentives for verifying the transaction by manually entering selected transaction information from the receipt.

In yet another embodiment of the invention, the ad campaigns associated with specified business locations can be further targeted by search criteria such as location category or keywords used in local searches, user demographics, and timeframes such as day of week and time of day when the advertisements should be offered.

In another embodiment of the invention, a customer communication device is presented for use at a local business location, which can assist with verification the location of the user in an indoor environment, and can be used to access advertisements and promotions offered to the user, as well as for transactions and payment processing. Another aspect of the invention is to get electronic confirmation of receipt of transaction on a user's mobile device using the customer communication device.

### BRIEF DESCRIPTION OF THE DRAWINGS

Foregoing aspects of the invention will become better understood by referring to the following description taken in conjunction with the accompanying drawings.

FIG. 1 is a block diagram of an exemplary system for implementing location based advertising with pay for performance based on customer visits and transactions.

FIG. 2 is a block diagram of an exemplary method for enabling local ads with a cost per visit model.

FIG. 3 is a block diagram of an exemplary method for enabling local ads with a cost per transaction model.

FIG. 4 is an exemplary illustration of enabling indicators for advertisements on a mobile device when searching for nearby locations.

FIG. 5 is an exemplary illustration of a banner local advertisement along with the details of the business location.

FIG. 6 is an exemplary illustration of details of the local advertisement with options to save and redeem the offer.

FIG. 7 is an exemplary illustration of a process for redeeming an offer.

FIG. 8 is an exemplary illustration of a process for verification of the transaction by capturing information from the receipt.

FIG. 9 is another illustration of a process for verification of the transaction by capturing information from the receipt using a scan of the receipt.

FIG. 10 is a block diagram illustration of associating a merchant with multiple business locations, and associating multiple ad campaigns for the same merchant with selected business locations.

FIG. 11 is an illustration of criteria that can be used for targeting a local ad campaign by business location, search criteria and temporal filters.

FIG. 12 is a block diagram of an exemplary device that can be installed at a local business location for accessing advertisements offered to the customer and verifying and electronically communicating transaction information.

### DETAILED DESCRIPTION

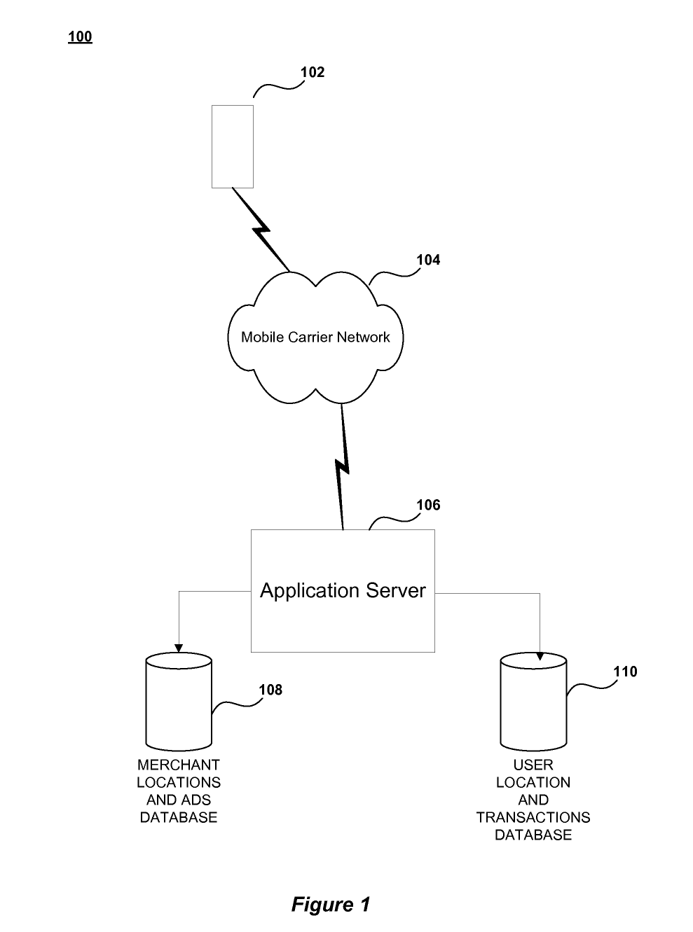

FIG. 1 provides a general description of an exemplary system 100 suitable for implementing location based advertising with pay for performance based on customer visits and transactions. Such an exemplary system includes a mobile device 102 capable of detecting or receiving geographic location information from a mobile positioning system such as a Global Positioning System (GPS) receiver embedded in the mobile device 102, and connected to a mobile carrier network 104 which offers voice, messaging and/or data services to mobile device 102. The mobile carrier network 104 is capable of transmitting text or data messages from and to the mobile device 102 and the application server 106, which includes the merchant locations and advertisements database 108 for storing advertisement and associated local business locations of a merchant where the merchant's products are offered, and a user locations and transactions database 110 that maintains the user's location, favorites, and transactions history for implementing such a pay for performance system.

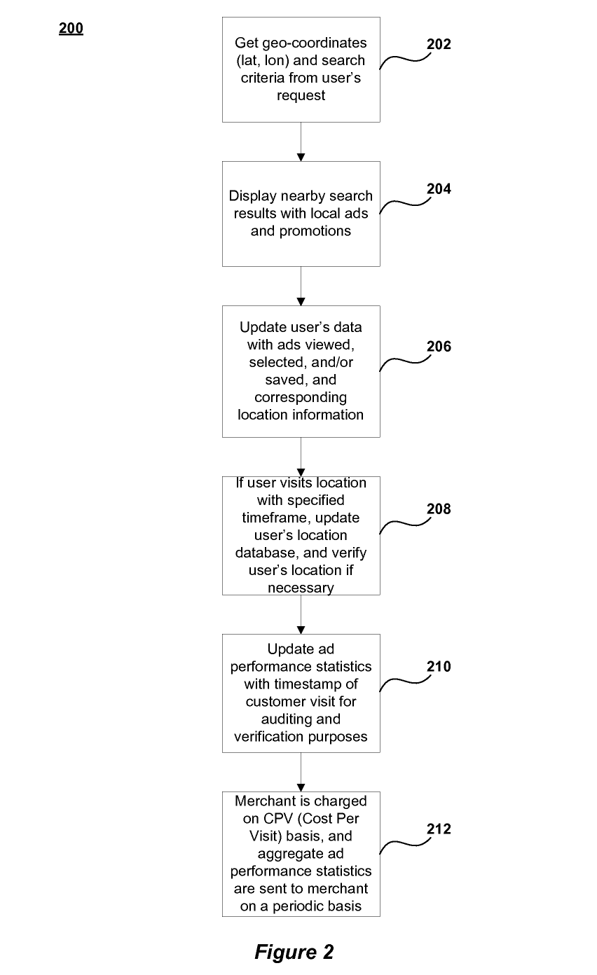

FIG. 2 is a block diagram of an exemplary method for enabling local ads with pay for performance based on a cost per visit model. In block 202, as the user initiates the request to search nearby locations based on specified search criteria, the mobile device 102 determines the current location of the user using a GPS or another mobile positioning system, and provides the geographic coordinates of the user to the application server 106. In block 204, the server determines nearby search results for business locations in proximity to the user, along with advertisements and promotions associated with these local businesses, and the results are displayed to the user as discussed later in the exemplary illustration 400. In block 206, the system updates the user's data with ads viewed, selected and/or saved on the mobile client or online, along with saving the corresponding business location, e.g. 414, associated with the advertisement in the user's locations and favorite database 110 with a reference code specifying user's action corresponding to the advertisement. In block 208, if the user is determined to be at the saved business location 414 within the specified timeframe, the user database 110 is updated accordingly, and if required the user is prompted to confirm the location for verification purposes. In block 210, the merchant and ad database 108 is updated with the timestamp of user's visit, and merchant's ad performance statistics are updated accordingly. In block 212, if the merchant's ad campaign is setup in the system based on a cost per visit (CPV) basis, the merchant is charged when the user visits the business location, and aggregate ad performance statistics are sent to the merchant on a periodic basis.

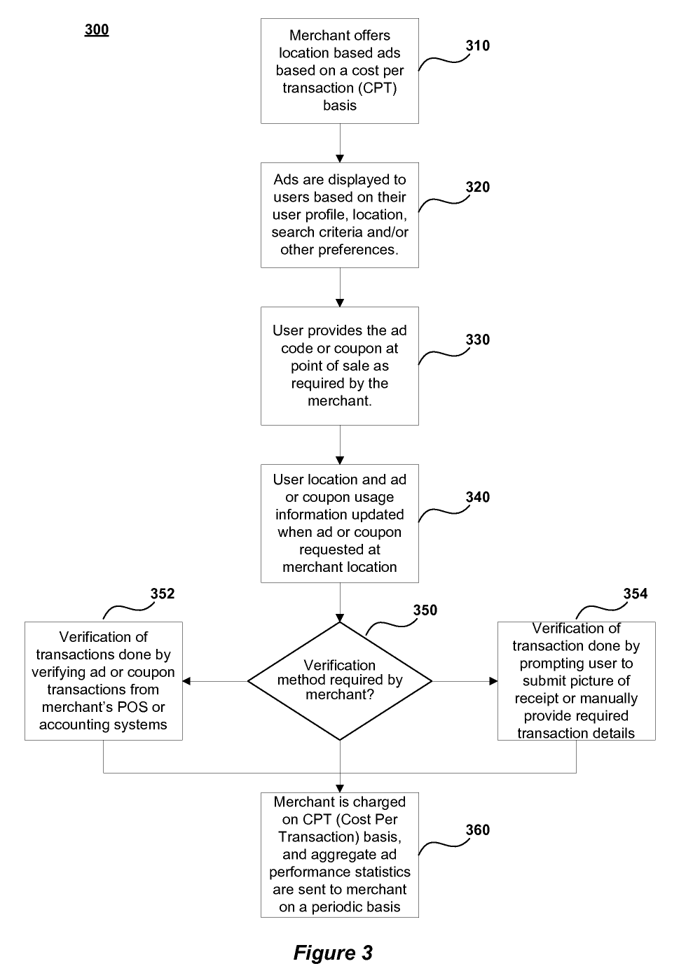

FIG. 3 is a block diagram of an exemplary method for enabling local ads with pay for performance based on a cost per transactions model. In block 310, a merchant offers local advertisements on a cost per transaction basis, and selects the options for verification of the transaction, which may include scanning a coupon code, a manual verification by the user, or other alternatives as maybe available for verification at the point of sale or for integrating with the merchant's accounting system. In block 320, as the user initiates the request to search nearby locations based on user's location and specified search criteria, similar to the steps in blocks 202 and 204, and the search results for business locations in proximity to the user, along with advertisements and promotions associated with these local businesses. In block 330, the user provides the ad or coupon code to the merchant at the point of sale, as required by the merchant, as discussed later in an exemplary illustration in 600 and 700. In block 340, as the user redeems the ad or coupon code at merchant location, the user's location and ad usage information is updated on the server. In the decision block 350, depending on the verification method required by the merchant, either an automated verification is performed in block 352 or a manual verification is performed in block 354 by prompting the user to confirm or to scan their receipt before updating the ad performance statistics corresponding to that transaction. Once the required verification is performed, in block 360, the merchant is charged based on the cost per transaction method, and aggregate ad performance statistics are sent to merchant on a periodic basis.

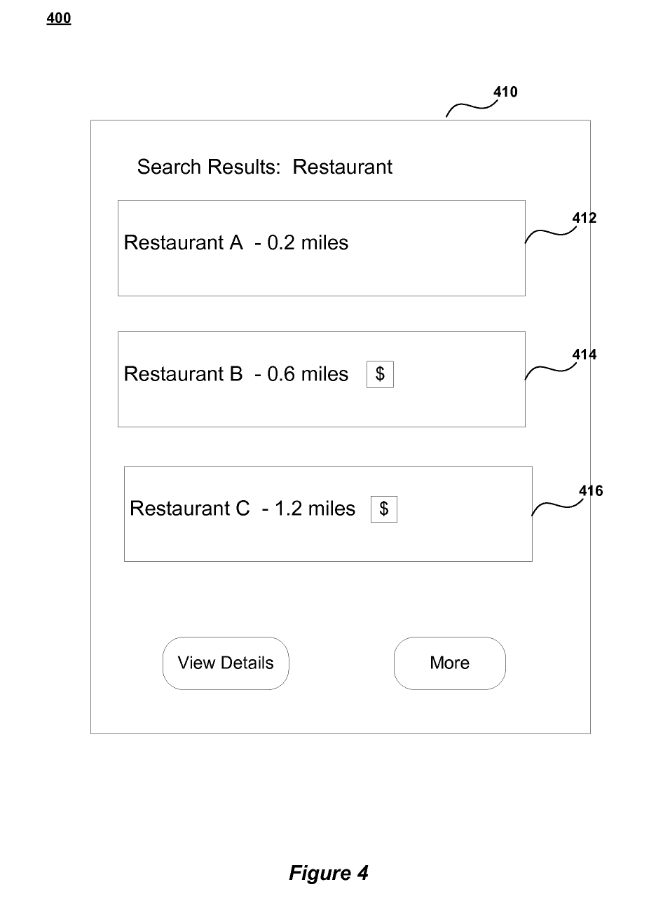

FIG. 4 provides an exemplary illustration 400 of displaying search results on a mobile device when searching for nearby locations, and displaying business locations that have advertisements and special promotions without making the advertisements intrusive to the user. In the example search results screen 410, the user searched for nearby restaurants, and the search results are displayed in 412, 414 and 416 in order of proximity, while at the same time, the search results in 414 and 416 have an indicator for an advertisement or special promotion offered at these locations. Upon selecting one of the search results and selecting view details option, or by clicking on one of the search results, the user is directed to the details of the location.

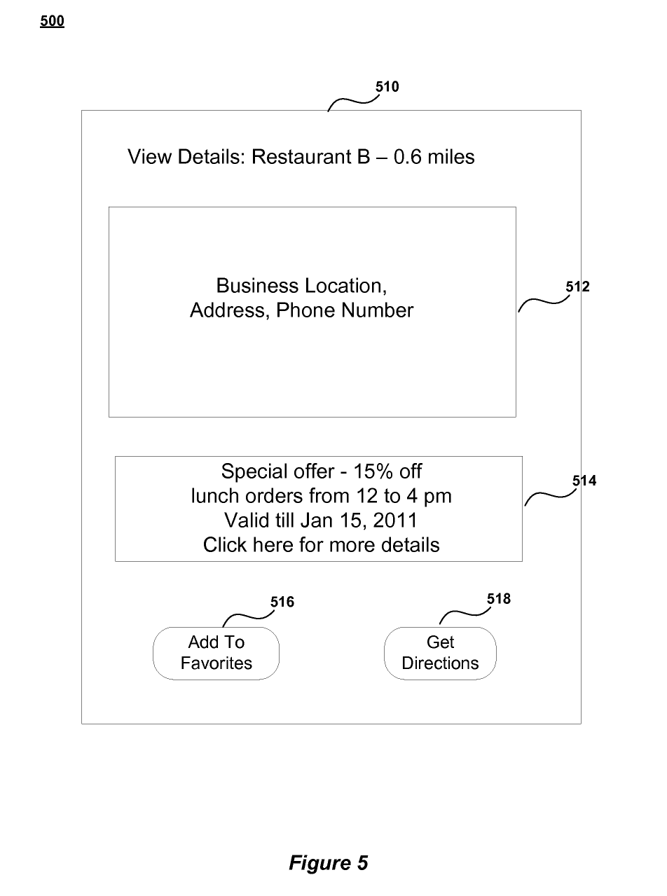

FIG. 5 is an exemplary illustration 500 of a details screen 510 for a business location which in block 512 includes the business location information and in block 514 includes a banner of the advertisement or special promotion offered at this location. In block 516, an option to add the business location to user's favorites is provided, which can make it easier for the user to view this location's details and advertisements at a later point. In block 518, the user can request directions to the business location, if this option is implemented. As the user selects the business location from search results and the details screen as in this illustration 500 is displayed, the business location is added to user's locations and favorites database with a code to indicate that the advertisement was viewed for this business location, and so if later the user visits this location, the ad performance statistics can be updated accordingly and the merchant can be charged per the cost per visit (CPV) or cost per transaction (CPT) method, as specified for this business location.

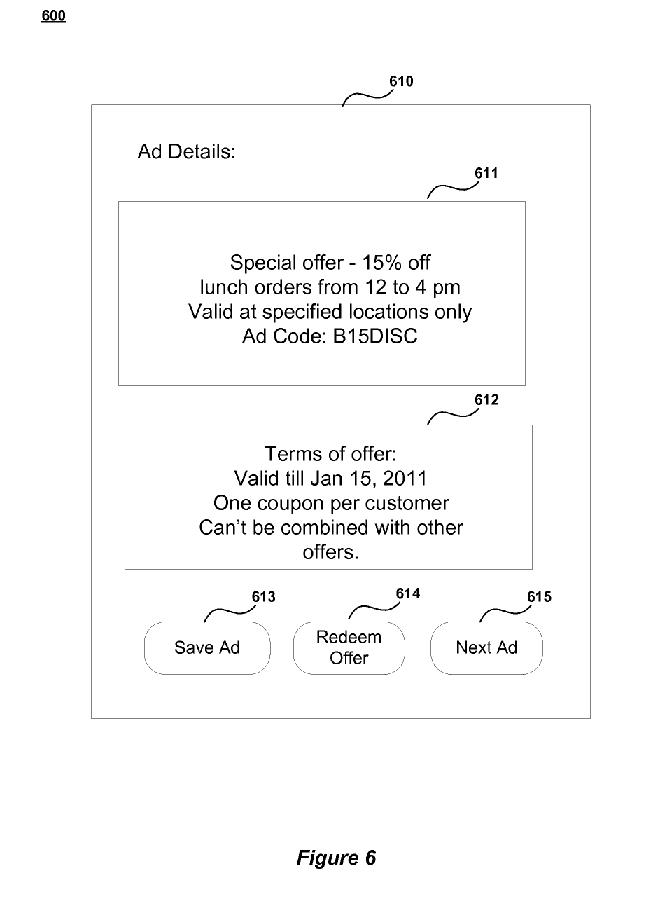

FIG. 6 is an exemplary illustration 600 of the advertisement details screen 610 with options to save and redeem the offer. In block 611, the offer details and the key information of the offer is presented, and in block 612, additional terms of the offer are presented. In block 613, an option to save the ad for future reference is presented, and in block 614, an option to redeem the offer is presented. Additionally, in block 615, an option to view additional advertisements for this location may be presented, if multiple advertisements or promotional offers are available for this business location.

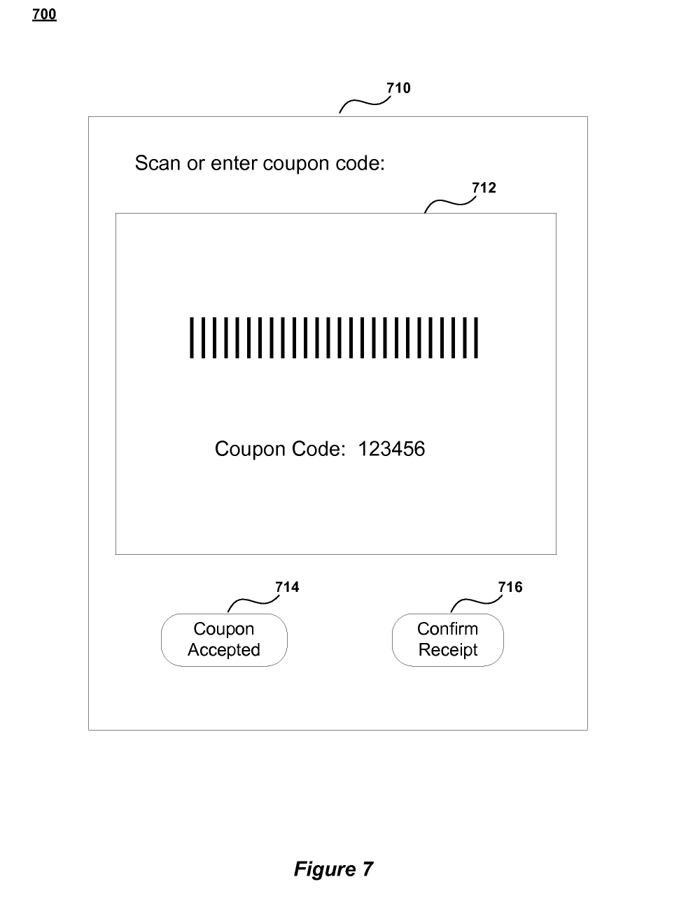

FIG. 7 is an exemplary illustration 700 of a process for redeeming an offer. In the exemplary case, as shown in the screen in block 710, a bar code is displayed in block 712 that can be scanned at the point of sale. Alternative options may be used on the mobile screen to provide the ad or coupon code to the merchant or at the point of sale of the business location. In block 714, an option is presented to allow the user to verify that the coupon was used and accepted. In block 716, an option for verification of transaction by confirming the receipt information is presented.

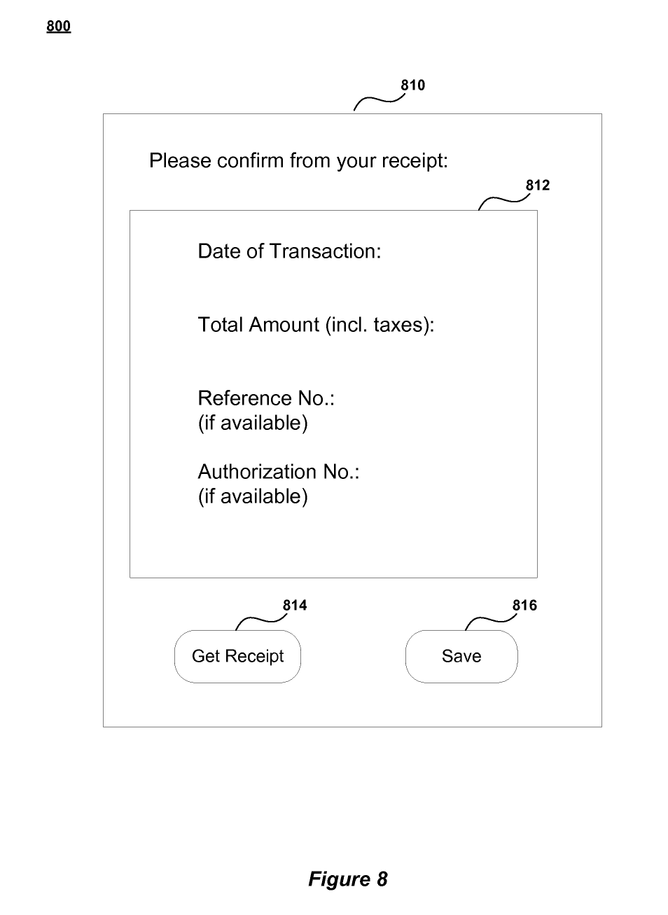

FIG. 8 is an exemplary illustration 800 of a process for verification of the transaction by capturing specified information from the receipt, as shown in the screen in block 810. In block 812, a user is presented an option to verify the information on the receipt by manually providing the required information such as date of transaction, total amount of transaction, reference number, and/or the authorization number of the transaction. In the block 814, an option is presented to the user to get an electronic confirmation of the receipt on their mobile device when such an option is available at the business location, and in block 816, the user can save the receipt information.

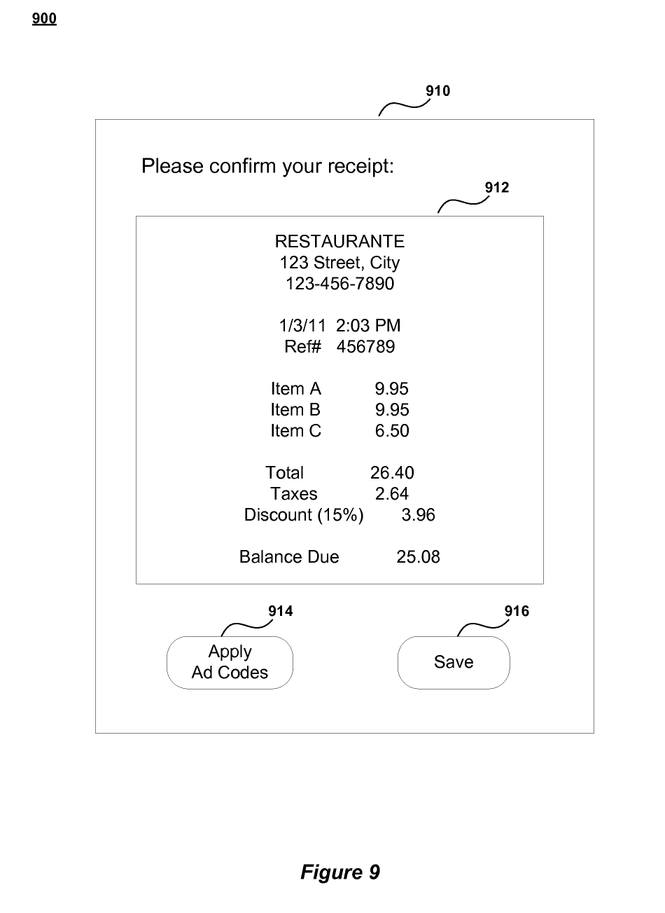

FIG. 9 is another illustration 900 of the process for verification of the transaction, and shows in block 910 an exemplary screen for capturing information from the receipt, and block 912 displays the scanned receipt information, and block 914 provides the option to initiate a request to access and apply the ad codes from the ads saved on the user's mobile device 102 or from the application server 106, and block 916 provides the option to save the receipt information.

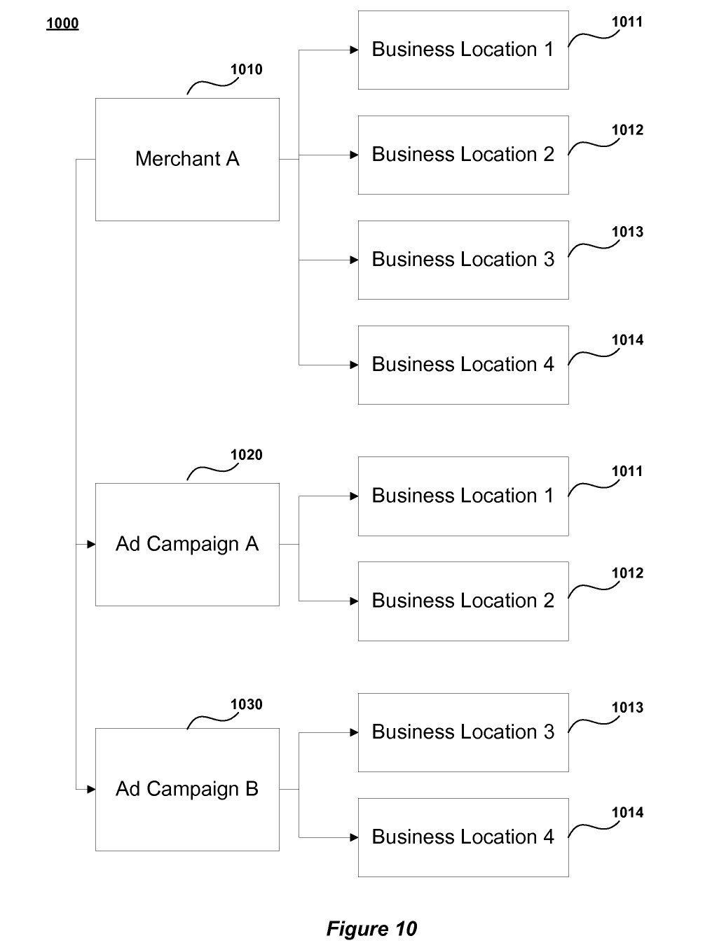

FIG. 10 provides a general block diagram 1000 for associating a merchant with multiple business locations, and associating multiple ad campaigns offered by the merchant with specified business locations. In this exemplary case, a merchant A in block 1010 is associate with business locations 1, 2, 3, and 4 as displayed in blocks 1011, 1012, 1013, and 1014 respectively. In this example, the merchant in block 1010 has two ad campaigns A and B as shown in blocks 1020 and 1030 respectively. The ad campaign A is only offered at business locations 1 and 2, and ad campaign B is offered at business locations 3 and 4. When these business locations will be displayed in search results, only the corresponding ad campaigns offered at these locations will be displayed.

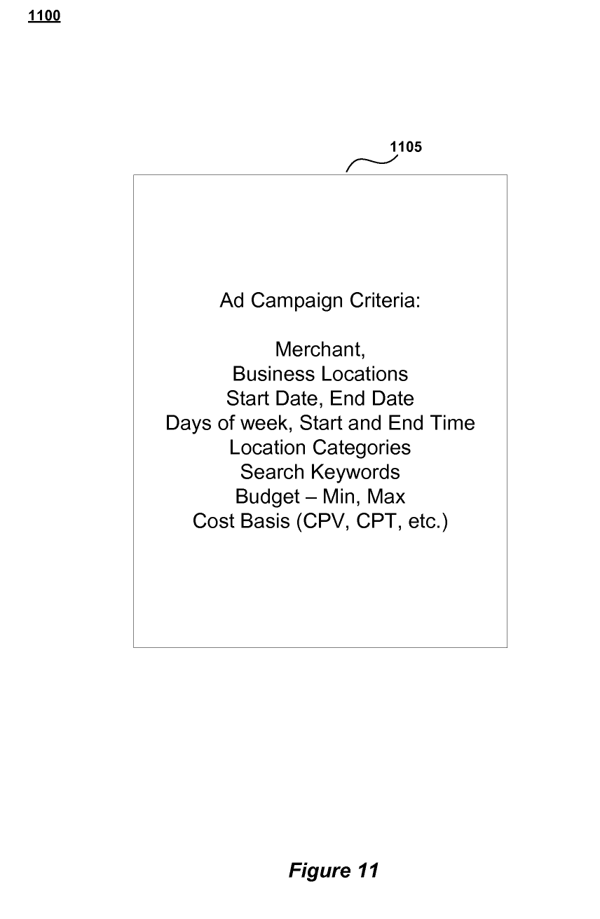

FIG. 11 is an illustration of additional criteria that can be used for targeting a local ad campaign, which as shown in block 1105, includes business locations, search criteria and temporal filters. The ad will be displayed in the target business location categories, or when the user searches for other specified keywords which can be alternative names or tags by which the business maybe searched. An ad can be configured to be displayed in search results only on specified days of week, and during specific hours of the day. Additionally, the ad campaign can be setup to start and end according to the start date and end date.

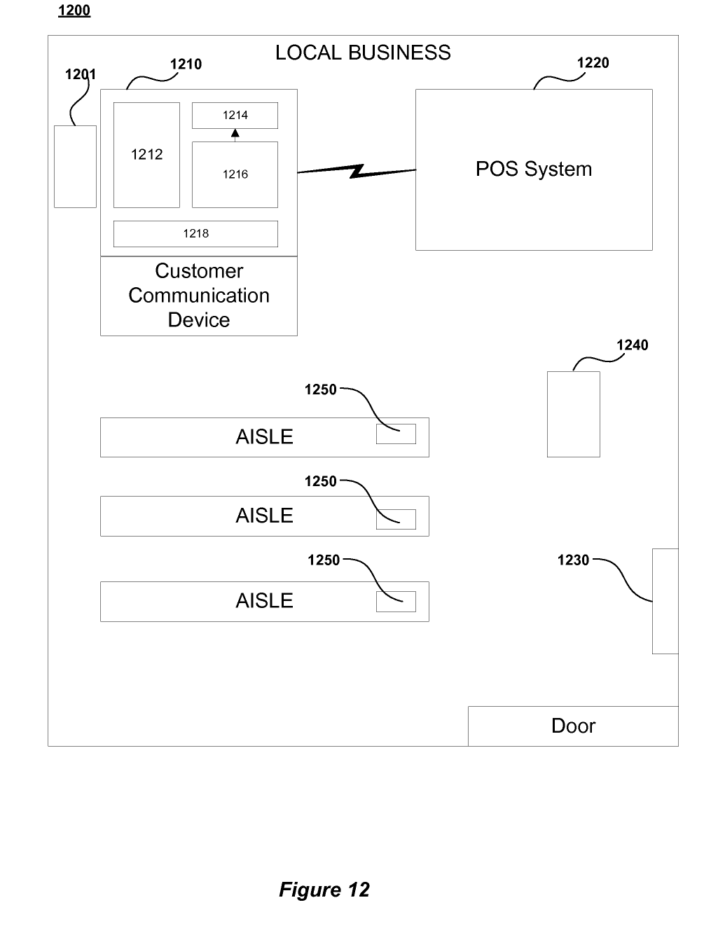

FIG. 12 is a block diagram of an exemplary customer communication device 1210 that can be installed at a local business location for accessing advertisements offered to the customer from the user's mobile device 1201 and verifying user's transaction and electronically communicating receipt information with the mobile device 1201. The customer communication device 1210 includes a proximity sensor such as a Near Field Communications (NFC) or an RFID Reader 1212, an indicator 1214 which can be an LED indicator to display when the mobile device 1201 is able to successfully communicate with the customer communication device 1210. Additionally, the customer communication device 1210 may also include a display screen 1216 and an input mechanism 1218 for interactive communication with the customer.

The customer communication device 1210 is capable of communicating with the point of sale system 1220 using a wired or wireless connection. As the user brings the mobile phone device in proximity of the customer communication device 1210, the identity information of the user is accessed and verified with the application server 106, and the ad codes associated with the advertisements and promotions offered to the user are communicated to the point of sale system.

As the transaction is completed, the point of sale system 1220 applies the applicable ad codes, and communicates the electronic receipt information to the customer communication device 1210 which can then transmit to the mobile device of the user when the mobile device is held in proximity of the device.

An extension of the customer communication device can be installed at the door-entry so that when the user enters the local business, they can hold the mobile device next to the customer communication device extension 1230 to access the advertisements and promotions on their mobile device. A handheld version of the customer communication device 1240 can be used by the customer service representatives to access advertisements and promotions while taking orders and during transaction and payment processing from user's mobile device. Additional customer communication device extensions 1250 with interactive display and input options can also be installed in different sections of the local business for communicating with the user and their mobile device for accessing advertisements, promotions, and other relevant information.

I/We claim:

1. A system for offering and measuring performance of location based advertisements, comprising:
at least an application server capable of accessing advertisements from an advertisement database or from another advertisement server;
at least the application server is capable of accessing business locations associated with said advertisements;
at least the application server is capable of determining if a user visited an associated business location within a specified timeframe of accessing or viewing the advertisement;
wherein the performance of said advertisements can be measured based on user visits at the associated business locations within the specified timeframe of the advertisement.

2. The system of claim 1:
wherein the cost of said advertisements is based on a cost per visit (CPV) and the number of user visits to the associated business locations within the specified timeframe of the advertisement.

3. The system of claim 1, including:
the application server is capable of serving said advertisements associated with business locations in proximity of the user's location or near a specified location.

4. The system of claim 1, including:
the application server is capable of serving said advertisements based on search keywords or criteria including one or more of:
location of search;
business name;
location category (e.g. Restaurant);
location sub-category (e.g. Italian Restaurant);
point of interest (Space Needle);
product categories (e.g. Pizza);
product name or model;
brand name;

5. The system of claim 1, including:
the application server is further capable of saving and retrieving advertisements that were previously searched, accessed, viewed and/or saved by a user when the user visits the business location;

6. The system of claim 1, comprising:
an application capable of displaying said advertisements to users that can be later accessed when the user visits the business location.

7. The system of claim 1, comprising:
a device installed at the business location for verifying the user's visit and transaction at the business location.

8. The system of claim 1:
wherein the cost of said advertisements is based on a cost per transaction (CPT) and the number of transactions resulting from the user visits within the specified timeframe of the advertisement.

9. The system of claim 1:
wherein the said advertisements can be offered based on advertisement campaign criteria that includes one or more of:
Business locations associated with the advertisement;
Start and End Date of the advertisement campaign;
Days of week, and starting and ending time of day during which the advertisement should be offered;
Location categories and/or Search Keywords specified by the merchant;
Advertisement budget limits specified by the merchant;
Cost criteria used for the advertisement;

10. A system for offering advertisements to and transacting with a user in a local business location, comprising:
at least a customer communicator device capable of accessing identity of a user from the user's mobile device when the user initiates action to share their identity with the local business at the point of use;
at least an application server that maintains identity of a plurality of users;
at least the customer communicator device can access the advertisement codes associated with the advertisements and promotions offered to the user;
at least the customer communicator device can communicate the user's identity to a payment processing system during a transaction;
wherein the promotions offered in the said advertisements can be applied when the user performs a transaction in the local business environment.

11. The system of claim 10, including:
the customer communicator device can communicate the advertisement codes associated with said advertisements and promotions to the payment processing system whereby said codes can be applied during the transaction without having to manually scan or enter the codes;

12. The system of claim 10, including:
the identity is an anonymous token assigned to the user for associating advertisements and promotions available to the user without disclosing the personally identifiable information of the user;

13. The system of claim 10, including:
the customer communicator device is further capable of communicating the user's credit card information and/or other payment credentials from the mobile device to the local business's payment processing system when the user initiates action to share their payment information during the transaction;

14. The system of claim 10, comprising:
the customer communicator device includes a proximity reader such as a Near Field Communications (NFC) or an RFID reader, and optionally a barcode and/or image based tag reader to access and associate advertisements and payment information of the mobile user.

15. The system of claim 10, including:
the customer communicator device is further capable of communicating its location to the mobile device and/or to the application server to determine the location of the user in an indoor environment.

16. The system of claim 10, including:
the customer communicator device is further capable of accessing the advertisements saved by the user on their mobile device, and communicating the advertisements from the application server to the user's mobile device.

17. The system of claim 10, wherein the customer communicator device is offered in multiple configurations and/or extensions, such that:
the customer communicator device is used as door-entry verification device and is placed near an entry of the business location, wherein users can swipe their mobile phone while entering into the local business location.
the customer communicator device is attached or embedded into the point of sale system.
the customer communicator device is a handheld device for use by customer service representatives while taking orders or for completing transactions.
the customer communicator is an interactive device for use in specific sections of a local business environment, and includes a display and input buttons for interactive use by the user in the local business environment.

18. A system for electronic receipt transmission during a transaction at a local business, comprising:
at least a customer communicator device capable of communicating with a user's mobile device at the point of sale using the Near Field Communications (NFC) technology;
at least the customer communicator device is capable of accessing the receipt information of a transaction from the point of sale system;
at least the customer communicator device can electronically send the receipt information of a transaction to the user's mobile device;
wherein the user can receive an electronic receipt on their mobile device during a transaction in the local business environment.

19. The system of claim 18, comprising:
the customer communicator device capable of accessing identity of a user from the user's mobile device when the user initiates action to share their identity with the local business at the point of use;

20. The system of claim 18, comprising:
the customer communicator device capable of accessing the electronic receipt information from the user's mobile device when the user initiates action to send the receipt information from the mobile device;
